(19) United States
(12) Patent Application Publication
(10) Pub. No.: US 2015/0112842 A1
(43) Pub. Date: Apr. 23, 2015

(54) PARTS EXCHANGE METHOD AND APPARATUS

(71) Applicants: Joseph Michael Sieger, Barrington, IL (US); Neil Sanders, Chicago, IL (US); Samip Jani, Westmont, IL (US); Ramya Dubbudu, Schaumburg, IL (US); Sharada Rajaraman, Aurora, IL (US)

(72) Inventors: Joseph Michael Sieger, Barrington, IL (US); Neil Sanders, Chicago, IL (US); Samip Jani, Westmont, IL (US); Ramya Dubbudu, Schaumburg, IL (US); Sharada Rajaraman, Aurora, IL (US)

(73) Assignee: INSURANCE AUTO AUCTIONS, INC., Westchester, IL (US)

(21) Appl. No.: 14/519,935

(22) Filed: Oct. 21, 2014

Related U.S. Application Data
(60) Provisional application No. 61/893,349, filed on Oct. 21, 2013.

(51) Int. Cl. G06Q 30/06

(52) U.S. Cl. CPC G06Q 30/0627
USPC 705/26.63

(57) ABSTRACT

A method and apparatus is provided for identifying parts of a vehicle. A method and apparatus is also provided for generating keywords and logic structures to access a part number database. A method and apparatus is further provided for use of the keywords and logic structure to access the part number database. Vehicle identifiers such as VIN numbers are utilized to determine vehicle parts so that vehicle parts for a vehicle may be determined from the vehicle identifier of that vehicle.

### CROSS-REFERENCE TO RELATED APPLICATION

The present application claims the benefit of provisional application Ser. No. 61/893,349 filed Oct. 21, 2013, which is incorporated herein by reference.

### BACKGROUND OF THE INVENTION

1. Field of the Invention

The present invention relates generally to a method and apparatus for determining part identification numbers of parts on a vehicle, and to a method and apparatus for providing part identification numbers for parts of a vehicle.

2. Description of the Related Art

Vehicles such as automobiles and trucks are sold with a variety of optional features from which the buyer of the new vehicle may choose when purchasing the vehicle. When the vehicle is sold as a used vehicle or when the vehicle is sold for parts following an accident or other damage to the vehicle, the buyer of the used or damaged vehicle may desire to know what optional parts are on the particular vehicle.

For example, a purchaser of damaged vehicles for parts may be in need of a halogen headlight assembly for replacing a damaged headlight on a vehicle under repair. If the vehicle under repair was originally sold either with an option of a halogen headlight assembly or a xenon headlight assembly, the purchaser of vehicles for parts would be unable to tell if a same make, model and year of vehicle as the vehicle under repair has the halogen headlight assembly or the other headlights. Of course, similar issues may arise with other parts, other options, and other vehicles.

Makers of vehicles often release different models or model configurations of new vehicles each model year or at other intervals. The different model configurations may have different features, different trim elements or otherwise differ from prior model years of the same make and model. However, the maker may use the same type of parts on different model years of the vehicle model. For example, a particular make and model of vehicle may use the same hood or the same headlight assembly over the course of several model years, even though other features of the vehicle are changed at each model year. Manufacturers may also use the same type of part in more than one model of vehicle.

A purchaser of vehicles for parts who is looking for a particular part for a particular make, model and year of vehicle would benefit from knowledge that the desired part may be obtained from the same make and model of vehicle but that is from a different model year. The purchaser of vehicles for part would benefit from knowledge that a desired part may be obtained from a different model of vehicle than the model for which the part is desired.

Services, such as services dealing in used vehicle parts, have generated part numbers for respective vehicle parts by which the parts may be identified within the service company. The generated part numbers differ from the original part number used by the vehicle makers to identify the parts during manufacture. The part numbers are provided in a uniform format and are cataloged by the service. Some part numbers have become standard identifiers for the particular part and are used to identify that part throughout the industry. An example of such part numbers are part numbers by Hollander, where the part numbers are provided as the Hollander Interchange.

### SUMMARY OF THE INVENTION

The present invention provides a method and apparatus for identifying parts of a vehicle. The invention also provides a method and apparatus for generating keywords and logic structures to access a part number database and a method and apparatus for use of the keywords and logic structure to access the part number database. Vehicle identifiers such as VIN numbers are utilized to determine vehicle parts so that vehicle parts for a vehicle may be determined from the vehicle identifier of that vehicle.

### BRIEF DESCRIPTION OF THE DRAWINGS

FIG. 1 is a screen shot of a computer program interface to translate a portion of a parts interchange number database into key words in logic operations;

FIGS. 2-5 show a use of a logic structure once it has been generated by the present preferred embodiment;

FIG. 6 is a table illustrating results of an analysis performed on information obtained by the operation of the preferred embodiment, a sample of which is shown in FIGS. 2-5;

FIG. 7 illustrates an interface provided to a reviewer that enables the reviewer to view a logic tree as shown to the left in FIG. 7;

FIG. 8 illustrates keyboard entries;

FIG. 9 illustrates an interchange mapping tool or user interface with an interchange tree window open;

FIG. 10 illustrates an input and a resulting output from a user command entry; and

FIG. 11 is a flow chart of use of the logic structure of the preferred embodiment that has been created.

### DETAILED DESCRIPTION OF THE PREFERRED EMBODIMENTS

A part number database includes descriptors of characteristics to guide a user in determining the part number of a part. The descriptors are generally understandable to a person (a human) but often do not provide information that is structured so that it is accurately understood by a computer. As such, a computer is unable to accurately access and utilize the part numbers in the database.

In an embodiment of the present method, a person reviews the descriptors associated with the part numbers in the database and provides known key words and possibly logic operators to a computer device for each descriptor in a form that is understood by a computer in translation or interpretation of the descriptor. The key words and logic operators as entered by the person are recorded by the computer device. The recorded logic indicators are assembled by a computer device into a logic structure or logic tree that may be used by a computer device to determine the part numbers of a vehicle from the database. Once the key words and logic structure is generated, the logic structure may be used by various computer devices to obtain the part numbers from the database.

In an exemplary embodiment, the part number database is a database of part numbers for vehicles. Vehicle parts are identified by the part numbers. The part numbers may be used by vehicle recyclers, vehicle salvage entities, vehicle repair entities and others to identify a part. For example, a hood of a particular make, model, and year of a vehicle is provided with a certain part number. The part number applies to the hoods of all of the vehicles of that make, model, and year that are of the same configuration and material and that could be interchanged as a replacement part for the hood on the vehicle. The part number from the part number database may be distinct from the part number of the hood used by the manufacturer during manufacture of the vehicle. The part number from the part number database may be referred to as an aftermarket part number or a parts interchange part number.

A vehicle repair service that is repairing a damaged hood of the particular make, model and year of vehicle may determine the parts interchange part number of the hood and using the parts interchange part number may inquire about obtaining a replacement hood for the vehicle. Ideally, the replacement hood is an exact match for the original hood on the vehicle, except of course for paint color and/or decorative elements such as striping or decals.

Some makes and models of vehicles may use the same hood part type, meaning a hood of the same configuration and style, for several model years. It is possible for the vehicle repair service to obtain a replacement hood from the same make and model of vehicle but a different model year vehicle than the vehicle being repaired. The different model year hood will be an effective replacement part for the hood of the vehicle being repaired. Other parts may be interchanged between model years as well.

A vehicle manufacturer may have several different models of vehicle that it manufacturers. Some parts of those vehicles are the same part type between different models of the manufacturer. For example, a same transmission type may be provided on several different models by the manufacturer. A repair shop seeking a replacement transmission for a particular make, model and year of vehicle would be able to use a transmission from a different model of vehicle from the same manufacturer. Other parts may of course be interchanged between different models of vehicles. It is also possible that some part types are common to different makes of vehicles.

The present computer logic generated by the present method is able to determine from the part number database which parts may be shared between different model years, between different models and between different makes of vehicles. The computer logic makes is possible to map the changes and similarities in part types across vehicle makes, models, and years. The computer logic as generated and used according the present invention makes it possible to determine the part numbers of various parts on a vehicle by inputting a VIN (vehicle identification number) or other information of the vehicle into the computer device.

Each model year, and sometimes more often such as during the model year, manufacturers of vehicles release new models, new series, or new model years of vehicles. Each release of new models and model years of vehicles requires that new logic structures be generated for accessing the part numbers. Each time the part number database is updated with additional or different information, a change in the logic structure may be generated to provide computer access to the part numbers. In one example, an updated part number list or database is available each quarter, and a new logic structure is generated to access the part numbers in the database.

According to one embodiment of the method, a person or several people review the characterizations of the part numbers used in the parts interchange database. The person or persons decipher the meanings of the descriptors or characterizations in the database. The person extracts VIN information or other vehicle information from the database that links information in the VIN to the features, options or parts of the vehicle. The person interprets the characterizations in the database and enters one or more commands into a computer device, wherein the commands may be interpreted by the computer device as a logic indicator. The commands entered by the person include key words and logic operators, which after being entered by the person or persons are assembled into the logic structure, the use of which is described herein. According to one use of the logic structure, the VIN of a vehicle may be decoded and linked to the part numbers on the parts interchange database for the parts of that vehicle.

In one example, the person or persons examines a characterization “sedan” and understands that this describes the overall configuration of the vehicle. The person examines the characterization “halogen” and understands that this describes the headlights of the vehicle. The person examines the characterization “leather” and understands that this describes the material used in the seats and/or interior of the vehicle. From these characterizations, the meanings and/or context of which may be unintelligible to a computer device, the person enters the key words and logic commands that can be understood by the computer device.

The VIN decoding process provides a logic tree having multiple levels. For example, a portion of the VIN may indicate if a vehicle is a sedan or a coupe. The logic tree determines that the vehicle is a sedan, for example. For a sedan, another portion of the VIN is examined, for example the eighth digit. If that digit is a “B,” for example, the logic determines that the vehicle has a front bumper of a particular part number. A similar process of following a logic path while examining the VIN can determine the part number for the hood of the vehicle. According to one aspect of the present method, one or more persons review the human readable information of the parts interchange list and generate a logic tree that enables the computer to read the VIN and determine the part numbers of the parts that are present on the vehicle. The computer readable list is a combination of keywords and logic operations.

The present method and apparatus provide a way for an entity that handles vehicles, such as used or damaged vehicles, to gather information to programmatically identify the interchange numbers for parts on the vehicle. This information can be obtained when the vehicle is initially assigned to the entity or when the vehicle is checked in by the entity, or at any other time. The part number information is gathered from the VIN of the vehicle. It is noted that the VIN includes information on the configuration of the vehicle in the first eleven digits. The VIN is a 17 digit number and character sequence. The last six digits of the VIN are a sequence number or identifying number for that specific vehicle, as opposed to a vehicle of the same type.

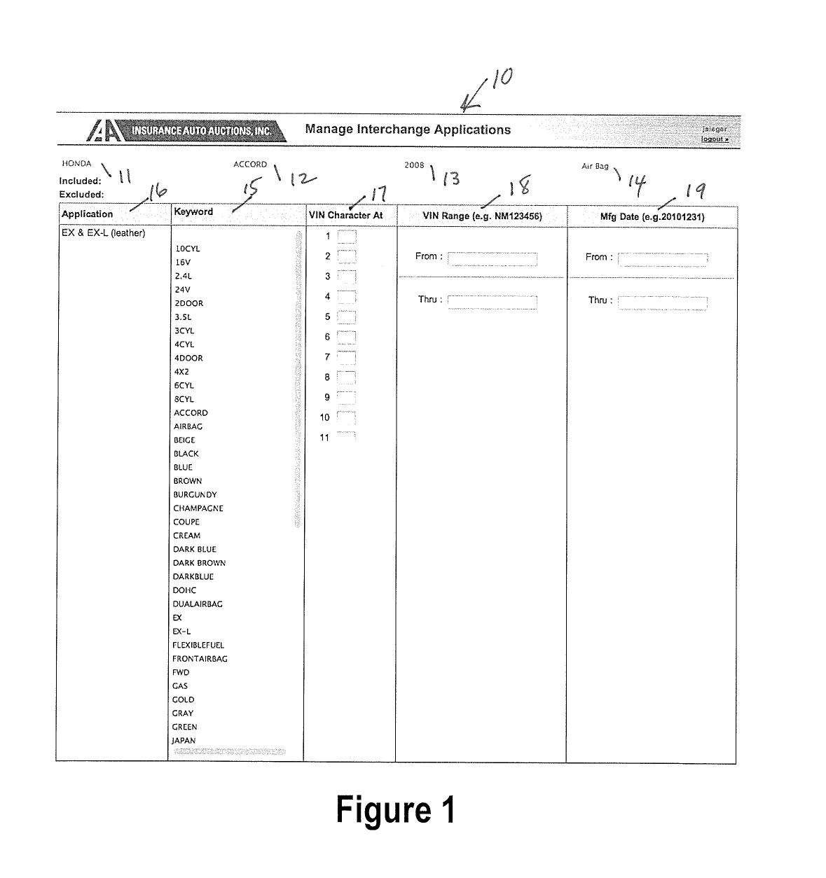

In FIG. 1, a screen shot of a computer program interface 10 that is used by a person to translate a portion of a parts interchange number database into keywords and logic operations. The illustrated application is directed to parts for a particular vehicle, here a 2008 Honda Accord and in particular the EX and EX-L series of the Honda Accord. The screen shows the make 11—Honda, model 12—Accord, year 13—2008, and a part type 14—airbag, across the top of the display. The computer interface operates to proceed through the part types for a vehicle, one part type at a time. After the user has addressed the descriptors for the “airbag” part type, the user may be presented with the part type “hood” or “headlight assembly” or “transmission,” which ever part type the computer system next presents to the user for review. As noted, the process proceeds one part type at a time.

For a part type, the interchange parts database includes text strings as descriptors of the part type. The computer system presents to the user for interpretation each text string that appears as a descriptor for that part type in the parts interchange database. The user is asked to link that text string to a known keyword 15 in the system and to provide any logic operators necessary for an accurate interpretation of the text descriptor. In a left application column 16, captioned application, is a text descriptor that has been found in the listing for the part type. In particular, the 2008 Honda Accord airbag part type listing in the interchange database includes a text descriptor “EX & EX-L (leather).” The person reviewing the descriptor text string may recognize that EX & EX-L (leather) refers to the EX series of the Honda Accord and to the EX-L series of the Honda Accord, which includes a leather interior as indicated by the text in parenthesis. The user recognizes that a vehicle cannot be both an EX and an EX-L, it can only be one or the other. The ampersand (&) refers to the fact that the same airbag is used in both the EX and the EX-L series of this make and model. A computer would interpret the & as a logical AND, resulting in no vehicles being found since the EX AND EX-L condition is an impossibility.

The user is to locate the known keywords 15 that correspond to this text string and to provide any logical operator required. Here, the user would locate the “EX” keyword in the keyword listing and enter it into the system for this descriptor. The user would locate the keyword “EX-L” as well in the keyword listing and enter it into the system. The user would enter a command to indicate that the two keywords are linked by a logical OR operator. A vehicle that is either an EX series or an EX-L series would have the airbag part type. Once the keyword and any logical operator is specified, the computer device advances to the next character string in the database for the part type “airbag.”

After all character strings for the part type “airbag” have been interpreted as keywords and logic operators, the computer system advances to the next part type. In this way, all part types of a vehicle are entered into the logic structure of the system.

A listing of known keywords drawn from the parts interchange is provided in the keywords 15 column. The keywords include descriptive terms that may describe a vehicle. Among the included terms are phrases such as 2door, 4door, coupe, 4cyl, 2.4l, and others. The user is to select from the known keywords, if possible. If an appropriate known keyword is not found in the keyword list, the system automatically enters the text string as a keyword in the keyword list.

The text string, or application 16—in the terminology used in the parts interchange list, may include a reference to a character in the VIN of a vehicle or may include an indication of a VIN range or an indication of a manufacture date or range. The next column 17 in the user interface is a list of the first eleven VIN number digits, which are the digits that carry the vehicle make, model and option information. The other VIN digits are used as a serial number to identify the vehicle. For each of the first eleven VIN digits, a data entry space is provided. If the text string or descriptor includes an indicator of a VIN character, this information is entered by the user in the VIN column 17. For example, a text string may say, “VIN character A, 6^{th} digit”. The user is to enter an “A” into the sixth space of the VIN column 17.

The descriptor may instead indicate a VIN range or a date range. The user enters into the next column 18 a VIN range by entering “from” and “thru” values into the text entry spaces. For date ranges, the user enters into the last column 19 a manufacture date range in the spaces for entering “from” and “thru” values.

A user utilizes the screen 10 as show in FIG. 1 to enter information from the parts interchange database wherein the entered information may be used by a computer device to obtain interchange part number information for parts on a vehicle upon entry of the VIN of the vehicle into the computer device or by entering keyword information describing the vehicle.

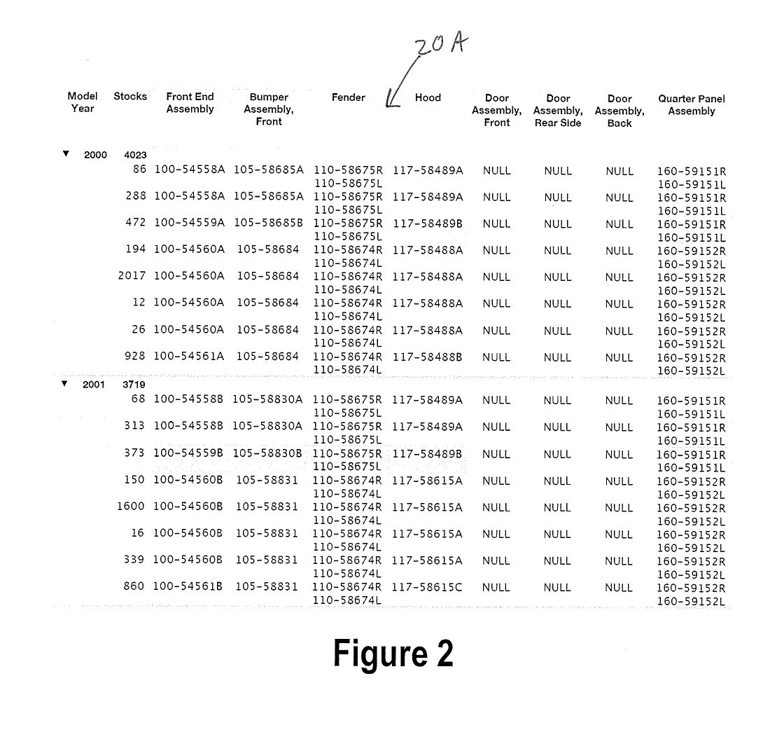

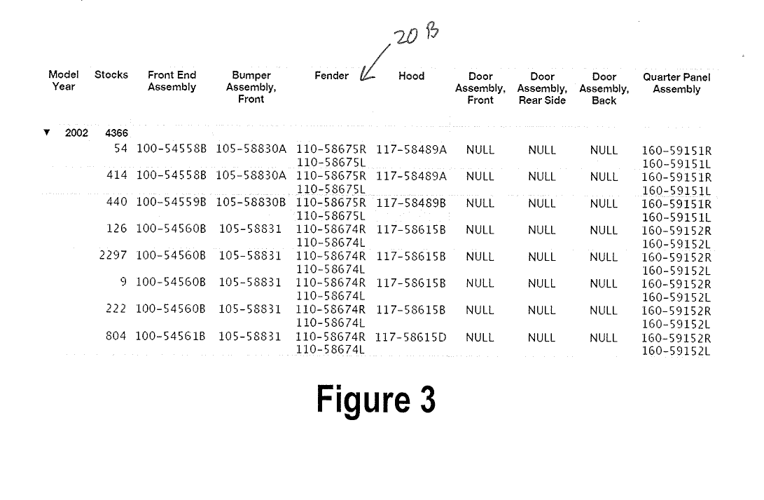

In FIGS. 2-5 is shown a use of the logic structure once it has been generated by the present method. The illustrated listing 20A shows model year 2000 to 2001 in FIG. 2 and in FIG. 3 the listing 20B shows model year 2002. Honda Accords that have been processed by a vehicle service, such as a vehicle auction service. The VIN information and/or keyword information about the vehicles has been entered into the logic structure that results from the user having entered the commands, as described above. As a result, information on a large number of vehicles has been processed to reveal not only part numbers but also patterns in the appearance of the part numbers in the vehicles entered. The listing 20A, 20B shows sets of vehicles that are grouped to show those that have certain parts in common. For instance, the listing 20A shows for model year 2000 Honda Accords that in this model year there are available four different front end assemblies, three different front bumper assemblies, two different fenders, and four different hoods. By comparing the part numbers of model year 2000 and 2001, it can be determined that the 2000 and the 2001 model years share the same hood, same quarter panel assemblies and the same fenders. Common part numbers are highlighted in the listing 20A.

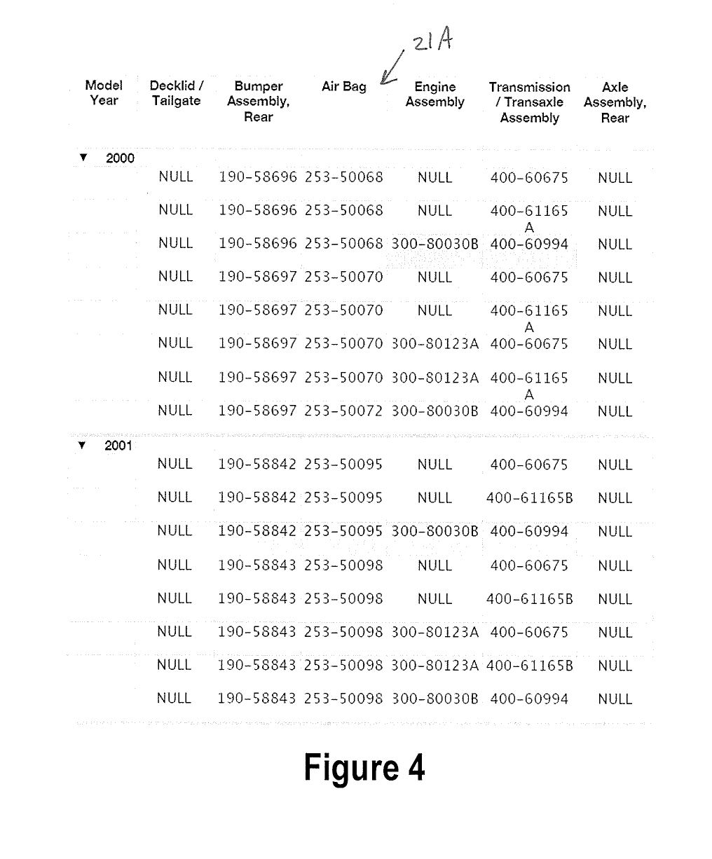

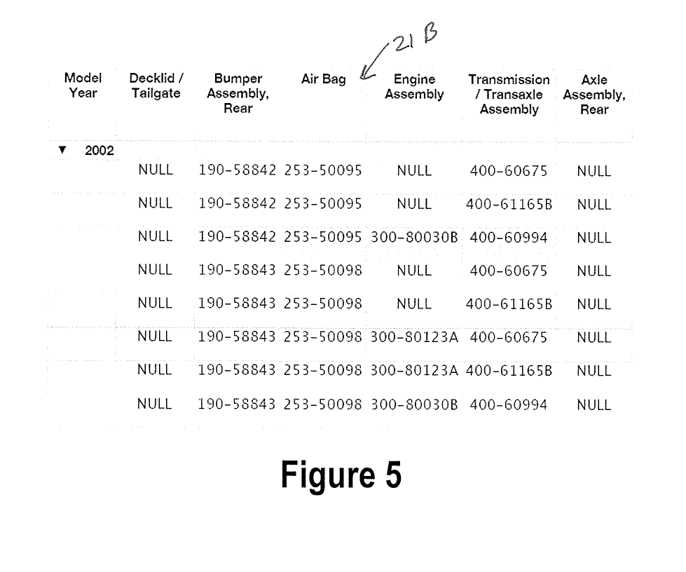

In FIGS. 4 and 5, it is also seen that the engine, transmission, airbags and bumpers are common parts across the listed model years. Other parts may be common as well.

The listings 20A, B and 21A, B of FIG. 2-5 also indicate a count of vehicles in stock that include the combination of parts as shown in the listings. The count of vehicles in stock may refer to current stock of vehicles at the company, or may include vehicles in stock over a span of time, for example. The vehicle count may be used to determine the scarcity of a part. For example, in FIG. 3, in the sixth row of the stocks column, only 9 vehicles has that combination of part types from a total of over four thousand vehicles entered. The part type for that set of vehicles may be considered scarce or difficult to find. Other part types are more or less common as can be determined from the analysis performed using the logic structure. Other uses of the logic structure are also possible.

In Appendix A is a worksheet that illustrates an interchange part number system. Pages 1-9 show part numbers for a 2005 BMW 330ci vehicle. The first page shows the front end assembly of the vehicle. The first level of inquiry is to determine if the vehicle is a: “Cpe”, “Cony”, or “Sdn”. A human can figure out this means “Is the 2005 BMW 330ci a Coupe, a Sedan, or a Convertible?” The human user enters the keywords for coupe (rather than Cpe), for sedan (rather than Sdn.) and for convertible (rather than Cony.). Assume the vehicle is a Coupe. The next branch is “xenon” vs. “halogen”. A human can figure out this means “Is the light fixture on the Front End Assembly for a Xenon bulb or a Halogen bulb?” Assume it is Xenon. The next branch is “adaptive light cont” vs. “w/o adaptive light control”. A human can figure out this means “Does the 2005 BMX 330ci have the ‘adaptive light control’ feature or not?” Assume it does have this feature. Then the Front End Assembly for this particular 2005 BMW 330ci is identified as part number 100-52545A, a.k.a., its interchange number.

Another example to look at on that same page of Appendix A is the Headlamp Assembly. The first level of its logic tree has “Cpe & Cony” as a possible branch. A computer would interpret the “&” to mean “AND.” A human can figure out the vehicle isn't referred to as both a Coupe AND a Convertible and that this means “The 2005 BMX 330ci is a Coupe OR a Convertible vs. it is a Sedan.” A logical OR operator is entered by the user.

Thus, the parts interchange listing includes operators (such as &) that have meanings contrary to the meaning if interpreted by a computer device. It includes terms that must be understood in the context of knowledge about vehicles and their features. The process of interpretation of the parts list information into a programmatic logic tree enables a computer to access the part number information.

Other examples of vehicle parts are shown in Appendix B pages 1-7 for a Chevrolet Malibu, and Appendix C for a Tundra on pages 1-7.

The logic structure as generated by the process described herein, for example, may be used to access parts information for vehicles according to another aspect of the invention. The use of the logic structure may be offered as a service, for example to subscribers who use the service that provides access to the part number information. Another use according to the invention is that the logic structure may be used to perform an analysis of vehicle information, or as a reporting function for part number of vehicles. The vehicles being studied using the logic structure may be either be vehicles handles by an entity or a wider range of vehicles such as within an industry, or area, or company, or other specifier.

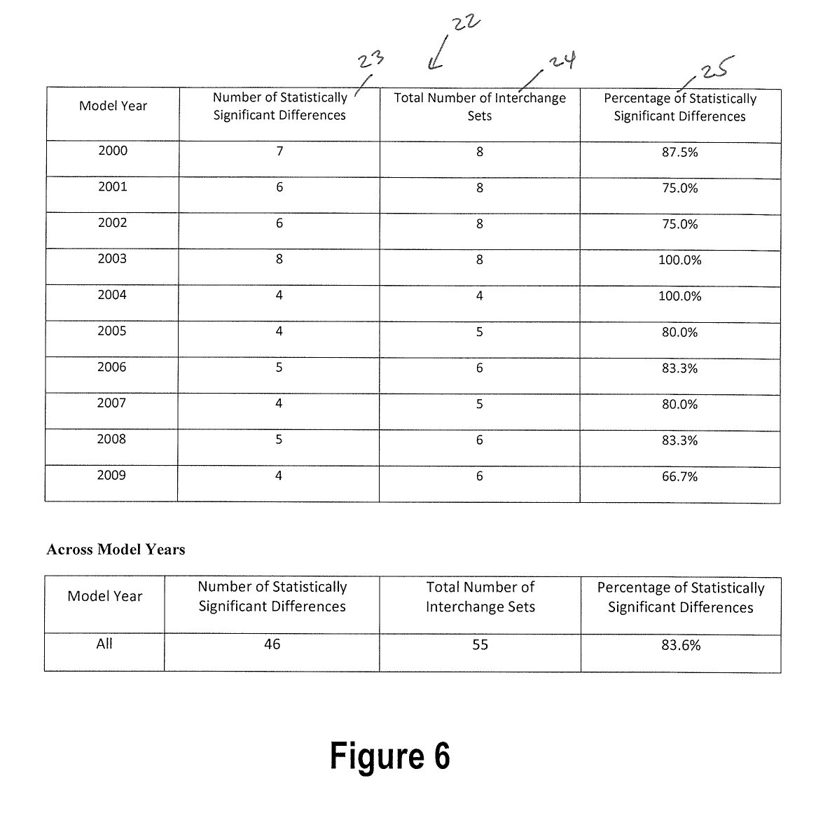

In one example, the information that may be obtained through the use of the logic structure about part type changes in model years or models may be utilized to indicate when a manufacturer made a major change to a vehicle model, or a minor change, or no change. For example, in FIG. 6 an analysis has been performed on the information obtained by the operation of the present method to create table 22, a sample of which is shown in FIGS. 2-5. The analysis considered the number of statistically significant differences 23, the total number of interchange sets 24, and the percentage 25 of statistically significant differences. By reviewing the analysis in table 22, it can be determined that some model years experiences a high percentage of different part numbers from the prior model year, while other model years experienced a lower percentage of changes in part numbers from the prior model year. The analysis table 22 thus indicates when a manufacturer has made a major modification of a model and when models have remained relatively similar. An entity looking for replacement parts may put a higher value on some vehicle sets that have a wider range of interchangeable parts and a lower value on a vehicle that has parts that can only be used on a few vehicles. A more scarce part or vehicle type may however garner a higher price due to its rarity.

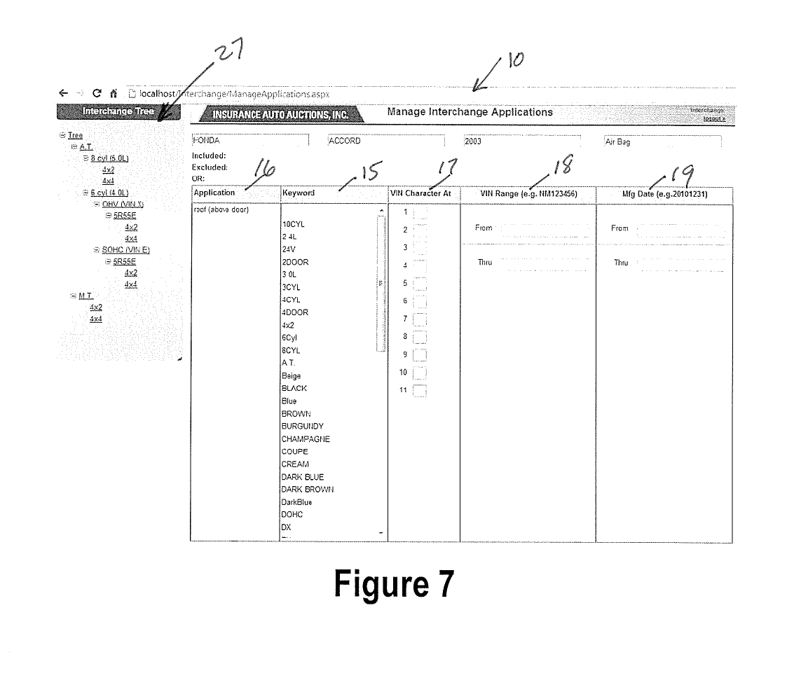

In FIG. 7, a reviewer is provided with the interface 10 on a computer program that enables the user to view a logic tree 27, as shown to the left in the Figure. The logic tree 27 as shown is the logic levels that are found in the parts interchange database. It may be necessary for the user to view this logic tree to understand the meaning of a text string, or to put the text string into context. The user then uses this understanding to pick the keywords that are listed in the keyword column 15 and to indicate logic operators. When working through the information presented, the user uses the keyboard of the computer device to enter commands.

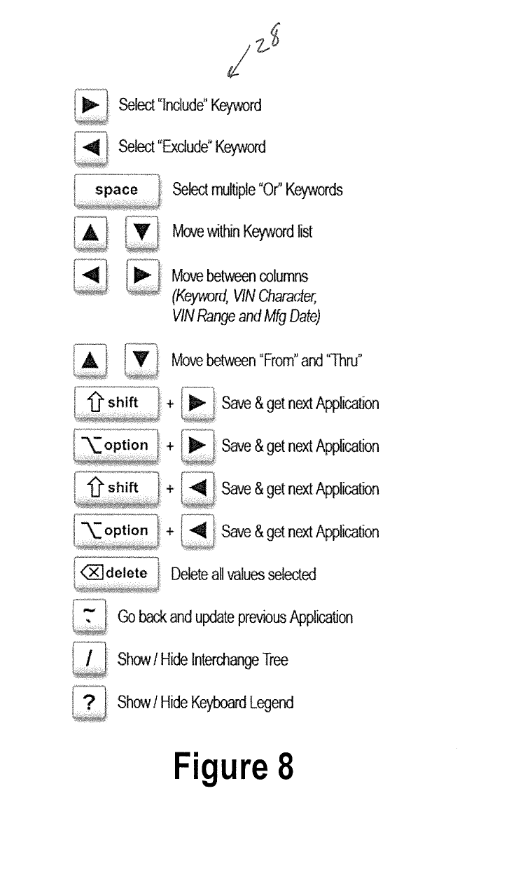

The keyboard entries 28 are shown in FIG. 8. The commands to be entered by the user are selected so as to minimize hand movement of the user on the keyboard. The keyboard entries by the reviewer are grouped by those relating to moving through the keywords and to indicate if the keywords are “including” or “excluding” keywords, moving between the from and thru data entry spaces on the display, saving and getting the next application or going back to the last application, and hiding or showing the interchange tree information. The user can chose to have the keyboard legend either remain on screen or be hidden by using a keyboard command.

The user is requested to review an application, or descriptor text string, for each make, model and part type in order to map the keywords. The make, model and part types are not editable by the reviewer. The “include”, “exclude”, and “or” commands are selected by the user as logic operators and are shown on the display. The application column of the display shows the application value, or descriptor text string, that needs to be mapped by the user. A keyword list is provided from which the user may select values that match the application value or descriptor text string. The VIN Character At portion of the display enables the user to enter the VIN characters at the positions 1 to 11 consistent with the VIN information contained in the descriptor text string. In one embodiment, the VIN character entry defaults to a particular position, such as the eighth position, which may be more commonly used to indicate that part type. Other default positions may be chosen, including using machine intelligence to default to the correct digit position for the part type. The user may use the up and down arrows to move between the positions, as needed.

If the descriptor text string (or application) indicates that the VIN may have multiple values then the user can enter multiple values in the VIN range column. The VIN range entry in the “from” and “thru” entries may depend on the prefix shown in the application value. If a range of dates is indicated in the descriptor text string, a manufacturing date range should be entered in the “from” and “thru” of the date range column. This may depend on the prefix shown in the application value.

The user is to select a keyword from the keyword list that corresponds to the text shown in the application or descriptor text string. For example, where the application shows “4Dr”, the user is to select the keyword “4DOOR”, where the application shows “1.6L (2 Dr)”, the user is to select the keyword “1.6 L 2DOOR.” Other examples are that the application may show “w/o” or “exc.” along with a keyword or “with” and a keyword, the user is to enter the keyword and indicate the logic structure as “excluding” or “included” the keyword. If an application has multiple values with either an “&” or other symbol or text, but an “ORr” is intended, the user is to indicate the “OR” by a keyboard entry. The user moves through the application and selects the corresponding keywords for each part type, and then moves through the keywords for other part types.

If a descriptor text string is already known, such as from a prior processing of the database for an earlier model year or for other reasons, that descriptor text string is not shown to the user for entry. The known descriptor text string is automatically entered into the logic structure. In this way, only changes to the logic structure are performed during a pass through the interchange database by a user.

Known keywords may be entered by the user from the list of known keywords. Unknown keywords may be entered by the user as well. Unknown keywords (new keywords) may be entered as a default value, for example on the bottom of the list of know keywords.

If the application shows that the VIN has a particular value at a particular position, the user is to enter that value at that position. If the application shows that the VIN has a set of values at a position, the user is to enter all those values at that position. Values may be presented in the application enclosed in brackets. The values in brackets may be entered as a keyword or ignored at the user's choice.

The program used by the user alerts the user if a value is not entered without mapping an application.

When using the user interface, the user's hand rests on well-chosen keys so as not having to move about over the keyboard, the display highlights for the user the anticipated keyword corresponding to the descriptor text string, and when a VIN is to be entered a jump to 8th character of VIN is provided.

A universe of potential keywords (e.g., remove spaces, “4×4”=“AWD”, keywords for location of part on vehicle) is presented to the user.

The boundary of YMM (year, make and model) vs. MM (make and model) (e.g., translating 2000-2012 Honda Accord as a group vs. individual years) may be determined. The user may use techniques of jump a level, indicated an empty branch of logic tree, or single branch of logic tree to enter information concerning the logic tree of the interchange database.

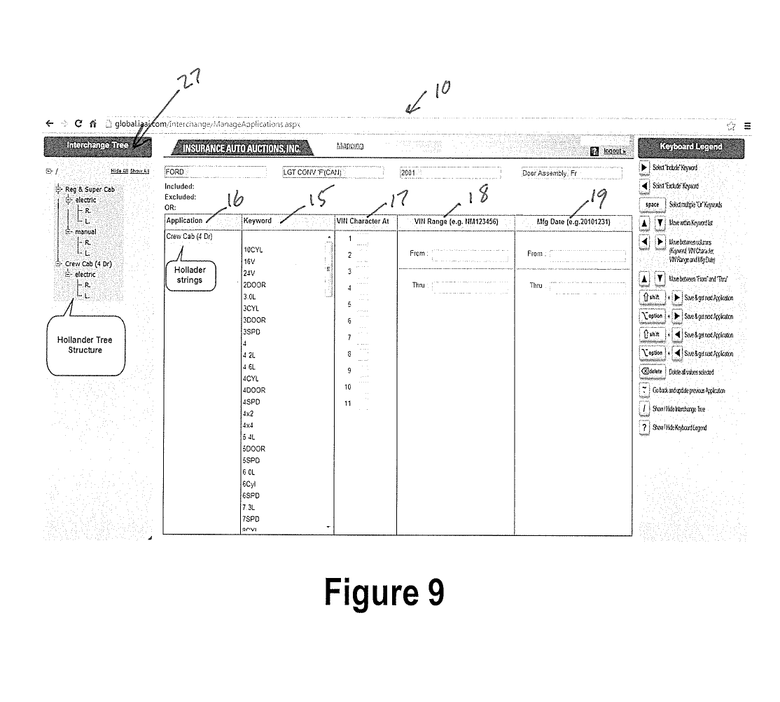

With reference to FIG. 9, the interchange mapping tool or user interface 10 is shown with the interchange tree window open. The vehicle being considered is a Ford LGT Cony F (Can), model year 2001. The part type is the front door assembly. The interchange tree 27 shows that the text strings for the descriptors include Reg & Super Cab and Crew Cab (4 Dr). The user has reached the descriptor Crew Cab (4 Dr). The user is to enter keywords and logic operators to enable this text string to be understood by a computer. The keyboard legend is shown to provide to the user a guide as to which keys should be entered for the commands.

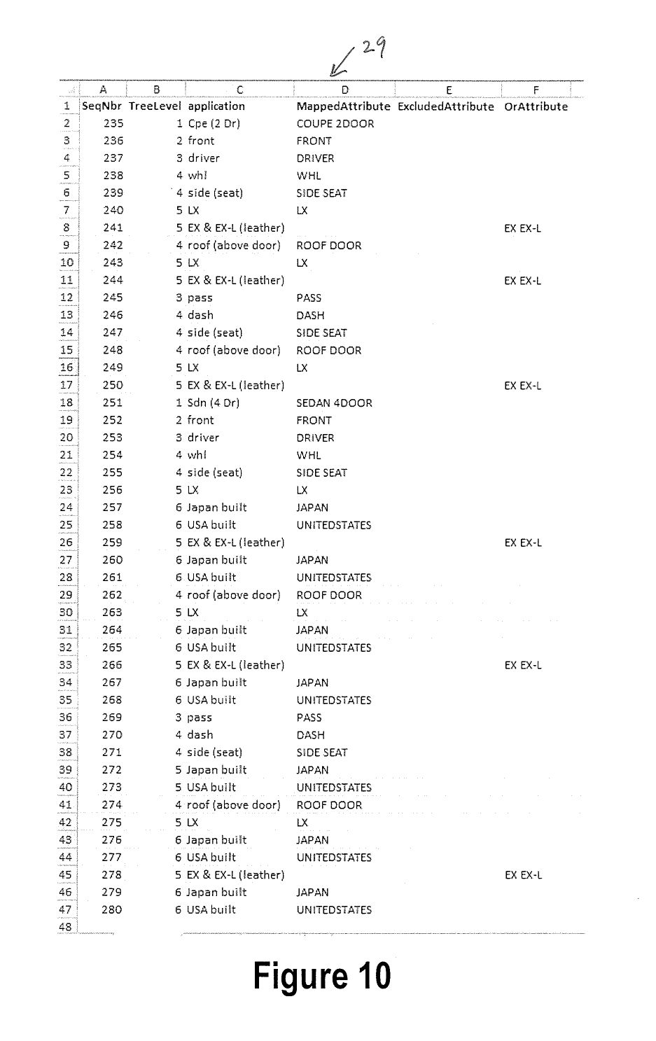

In FIG. 10 is shown at 29 an input and a resulting output from the user command entry. In column A is the sequence number of the text string, in column B is the tree level within the interchange database for the text string, and in column C is the text string that appears in interchange database. These are presented to the user for interpretation. The process has been performed on the text strings so that they are linked to known keywords. The column D shows the keyword value to which each text string is mapped. In the first row, the text string Cpe (2 Dr) is mapped to the known and computer readable value COUPE 2DOOR. If a text string includes an excluded value, such as indicating “without” or other exclusionary terms, the keyword appears in the excluded column E. For “OR” attribute values, the key words are shown in column F. For example in the eighth row, the values EX or EX-L, as discussed above appear in the OR attribute column, since a vehicle can be an EX series or an EX-L series. Of course, the mapping continues preferably for all parts of the vehicle or at least for all major parts and systems.

A computer device can utilize the logic of the columns D, E and F and potentially others to determine part numbers from vehicle information.

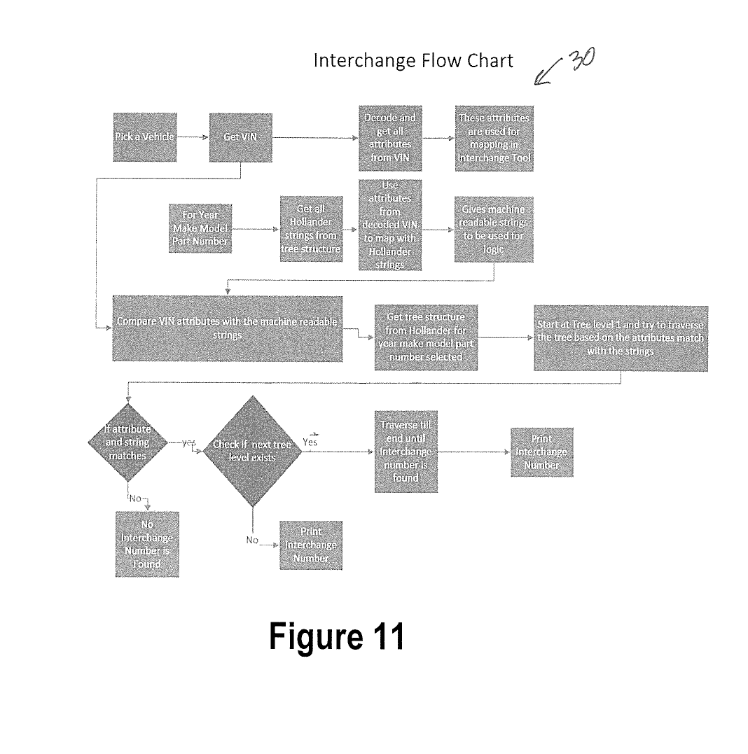

In FIG. 11 is a flow chart 30 of the use of the logic structure that has been created. A user may choose a vehicle, and enter the VIN into the system. The computer system decodes the VIN and gets all the attributes from the VIN. These attributes are mapped to the interchange logic.

The VIN also is provided to a comparison of the VIN attributes with the machine readable strings. For a year, make and model and part number, the system gets the parts interchange logic strings from the tree structure, uses the attributes from the decoded VIN to map to the interchange strings and gives machine readable strings used for the logic. This is provided to the comparison function. The comparison gets the tree structure from the interchange database for the year, make, model and part number selected. A start at the tree level one is provided and an attempt is made to traverse the tree based on the attributes matched to the strings. If the attribute and string matches, a check is made as to whether a next level exists. If so the levels are traversed until they end in the interchange part number. The number has been found and may be recorded or printed.

If the attribute and string do not match, no interchange number is found. If the tree has no next level, the interchange number has been found and the number is printed, saved or otherwise output.

Thus, an automated system is provided for determining the part numbers.

Thus, there is shown and described a method for translating an application field into keywords and logical operations and for the uses of the keywords and logical operations. Once translated, the keywords and logical operations can then be used programmatically to obtain Interchange numbers at large scale and high speed.

The present method and apparatus provides a disaggregation within the YMM (year, make and model) for analysis and reporting, and aggregation across YMM for analysis and reporting.

The North American recycling industry uses an interchange numbering system for parts. For example, a recycler will refer to the Hood on a 2000 Honda Accord by its Hollander Interchange number (“117-58489B”) because this same part is used on other year-make models (e.g., 2001 Honda Accord, 2002 Honda Accord). This part is interchangeable among these three year-make-models. When computing how much to bid at an auto auction, many recyclers use software that computes the value of the undamaged parts on a vehicle. The computation of value is based on Interchange numbers. Hence, if buyers are provided with the Interchange numbers, this saves the buyer time and reduces uncertainty about what parts are on the vehicle, therefore increasing the maximum the buyer is willing to bid. Benefits are provided from using Interchange data in an analysis and reporting.

The computer devices used in the present method and apparatus may include a personal computer, workstation, laptop or netbook computer, tablet computer, smart phone, personal digital assistance, kiosk or other computer device. The computer device may be stand alone or connected to a network such as a local area network, wide area network, the internet, or to the cloud. The application interface for the user to enter the logic structure and keywords or for a user to utilize the data may be stored locally on a computer readable hard disc, solid state memory or other tangible computer readable media. The data utilized in the method including the parts list, applications, and other data may be stored locally or located on a server or on several servers. The resulting logic structure may be stored and used locally or over networks or on servers.

Although other modifications and changes may be suggested by those skilled in the art, it is the intention of the inventors to embody within the patent warranted hereon all changes and modifications as reasonably and properly come within the scope of their contribution to the art.

We claim:

1. A method for determining part numbers of a vehicle, comprising:
generating logic paths to access a list of part numbers; and
using the logic paths to obtain part numbers of vehicles.

2. A method as claimed in claim 1 further comprising the step of determining part numbers of a vehicle from a VIN of the vehicle using a computer logic structure.
